(19) United States
(12) Patent Application Publication
(10) Pub. No.: US 2009/0057299 A1
(43) Pub. Date: Mar. 5, 2009

(54) INDUCTION COOKING APPLIANCE AND A METHOD FOR CHECKING THE COOKING CAPABILITIES OF A PIECE OF COOKWARE

(75) Inventors: CRISTIANO PASTORE, BORGOMANERO (IT); DAVIDE PARACHINI, CASSANO MAGNAGO (IT); DIEGO NEFTALI GUTIERREZ, VARESE (IT)

Correspondence Address: WHIRLPOOL PATENTS COMPANY - MD 0750, 500 RENAISSANCE DRIVE - SUITE 102, ST. JOSEPH, MI, 49085, US

(73) Assignee: WHIRLPOOL CORPORATION, BENTON HARBOR, MI (US)

(21) Appl. No.: 12/204,383

(22) Filed: Sep. 4, 2008

(30) Foreign Application Priority Data
Sep. 5, 2007 (EP) 07115692.1

(51) Int. Cl. H05B 6/12

(52) U.S. Cl. 219/626

(57) ABSTRACT

The present invention relates to induction cooking appliances which provide a user with an improved set of information concerning the cooking capabilities of a piece of cookware to be used in conjunction with said appliance. In a further aspect, the present invention concerns an improved method for checking the cooking capabilities of a piece of cookware to be used in conjunction with an induction cooking appliance.

### BACKGROUND OF THE INVENTION

1. Field of the Invention

The present invention relates to induction cooking appliances, such as induction hobs and the like. More particularly, the present invention relates to an induction cooking appliance, which provides a user with an improved set of information concerning the cooking capabilities of a piece of cookware to be used in conjunction with the appliance. In a further aspect, the present invention concerns an improved method for checking the cooking capabilities of a piece of cookware to be used in conjunction with an induction cooking appliance.

2. Description of the Related Art

Induction cooking appliances, such as induction hobs, are widely known. Such appliances rely on an induction heating mechanism in order to deliver heat to a piece of cookware such as pots, pans, casseroles or other cooking utensils. Heat transfer occurs by means of an inductive coupling between an inductor coil, which generates a time-varying magnetic field, and the piece of cookware itself. Thanks to this inductive coupling, the magnetic field generated by the inductor coil causes the so-called “eddy currents” to circulate in the piece of cookware. The presence of these induced currents determines heat generation, since the piece of cookware is provided with a certain electrical resistance.

The effectiveness of the heat generation mechanism basically depends upon some characteristic physical parameters of the piece of cookware (such as resistivity and magnetic permeability). Thus, it is apparent that the user should adopt suitable cookware in order to get good cooking performances. In particular, cookware having at least the bottom made of materials having good magnetic properties, such as magnetic stainless steel or other magnetic alloys, should be used.

Since the user may not be aware about the actual magnetic properties of the materials forming a certain piece of cookware, modern induction cooking appliances embed detection devices that are able to check whether a piece of cookware is suitable for use.

These detection devices usually check whether one or more physical parameters exceed or not predefined acceptable thresholds. For example, some detection devices monitor whether the active power delivered to the inductor coil overcomes a predefined level or whether the impedance power factor of the inductor coil is lower than a predefined value. If a certain piece of cookware is not considered as suitable, an alarm is provided to the user.

Known induction cooking appliances have some drawbacks.

A first drawback resides in the fact that the user merely receives a sort of go/no-go signal related to the suitability of a piece of cookware. This kind of advice is basically provided for safety purposes and it does not allow the user to understand the actual cooking capabilities of the piece of cookware.

In addition, it has been shown how some cooking utensils, not specifically conceived for use with induction cooking appliances, may be erratically judged as suitable for use, since very few physical parameters are actually checked.

On the other hand, some of these cooking utensils, not specifically conceived for use with induction cooking appliances, may be anyway used with induction cooking appliances, even if in non-ideal conditions. The user cannot be aware of this possibility for a certain piece of cookware since he/she can rely only upon the received go/no-go signal.

In addition, it has been proven that a relevant number of cooking utensils, which are signalled as suitable by the known embedded detection devices or which are explicitly declared as “compatible with induction” by the manufacturers, are often severely under-performing, leading to an increase of the heating time and to the degradation of the efficiency of the energy conversion process. Thus, the user may get unsatisfactory cooking performances that he/she can only refer to the overall quality of the induction cooking appliance rather than to the quality of the piece of cookware. This may result in unnecessary service calls and customer dissatisfaction.

### SUMMARY OF THE INVENTION

Therefore, an aspect of the present invention is to provide an improved induction cooking appliance.

It is another aspect of the present invention to provide an induction cooking appliance, which allows the user to receive an improved set of information concerning the cooking capabilities of a piece of cookware to be used.

It is yet another aspect of the present invention to provide an induction cooking appliance, which allows to check the cooking capabilities of a piece of cookware according to a wide plurality of different physical parameters.

It is also an aspect of the present invention to provide an induction cooking appliance, which is easy to manufacture at industrial level, at competitive costs.

Thus, the present invention provides an induction cooking appliance, according to the claim 1 proposed in the following.

In a further aspect, the present invention provides a method for checking the cooking capabilities of a piece of cookware, to be used in an induction cooking appliance, according to the claim 12 proposed in the following.

The induction cooking appliance, according to the present invention, comprises a control unit provided with detector for providing first data related to the impedance, specifically the complex impedance, which is at the input leads of the inductor coil of the appliance.

The use of the complex impedance allows to collect a wide range of information on the cooking capabilities and quality of a piece of cookware, which is associated to the inductor coil.

On the base of the first data, second data related to the performances of the piece of cookware in a variety of operative situations (e.g. at different cooking temperatures, at different magnetic field frequencies) can be easily processed and provided.

Thus, the user has available a wide range of information (and not mere go/no-go signals), which make him/her more aware of the capabilities of the available pieces of cookware, which can therefore be used in the most proper manner.

### BRIEF DESCRIPTION OF THE DRAWINGS

Further features and advantages of the induction cooking appliance, according to the present invention, will become apparent from the following description of preferred embodiments, taken in conjunction with the drawings, in which:

FIG. 1 represents a schematic diagram of the induction cooking appliance, according to the present invention; and

FIG. 2 represents a schematic diagram of a Half-Bridge converter, used in a first embodiment of the induction cooking appliance, according to the present invention; and

FIG. 3 represents a schematic diagram of a Quasi-Resonant converter, used in a second embodiment of the induction cooking appliance, according to the present invention; and

FIGS. 4-5 represent some schematic diagrams, each showing some parametric curves related to the complex impedance, which is estimated in the mentioned first embodiment of the induction cooking appliance, according to the present invention; and

FIG. 6 represents a schematic diagram showing some parametric curves related to the current in the inductor coil in the mentioned second embodiment of the induction cooking appliance, according to the present invention.

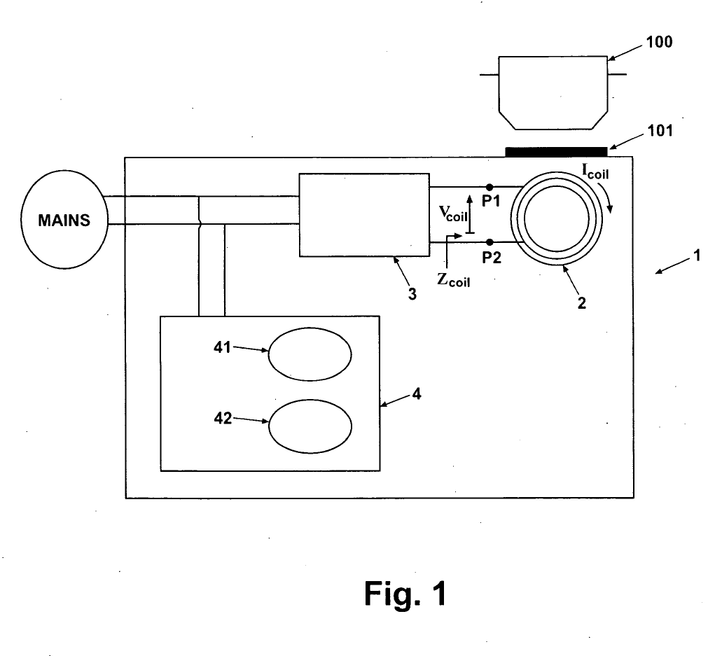

### DETAILED DESCRIPTION OF THE PREFERRED EMBODIMENTS

Referring now to the cited figures, the induction cooking appliance 1, according to the present invention, comprises at least an inductor coil 2, suitable to generate an AC magnetic field. Electronic driver 3 are provided for driving an AC current into the inductor coil 2. The appliance 1 comprises also a control unit 4 for controlling the operation of the appliance 1.

Of course, a piece of cookware 100 is used in conjunction with the appliance 1. The piece of cookware 100 is advantageously placed at a cooking region 101, so as to be inductively coupled to the inductor coil 2, when an AC magnetic filed is generated.

The generation of a time-varying electromagnetic field is required to cause the eddy currents to arise and flow in the piece of cookware 100, thereby causing its heating.

It should be noticed that the inductive coupling between the inductor coil 2 and the piece of cookware 100 can be modeled as an electrical transformer, in which the inductor coil 2 constitutes the primary winding and the piece of cookware 100 constitutes the short-circuited secondary winding. The model transformer has a secondary load that is almost resistive, since it is mainly originated by the resistance of the piece of cookware 100. The secondary load is mirrored at the primary winding (i.e. at the inductor coil 2), given the presence of a certain coupling factor between the primary and secondary windings.

The electronic driver 3 (which comprise one or more switching circuits SW1-SW3) form a resonant converter 3A-3B in association with the inductor coil 2, which provides in output a square voltage waveform that is applied to a resonating circuit (31A-31B) including the inductor coil 2 itself and one or more capacitors (C1-C3).

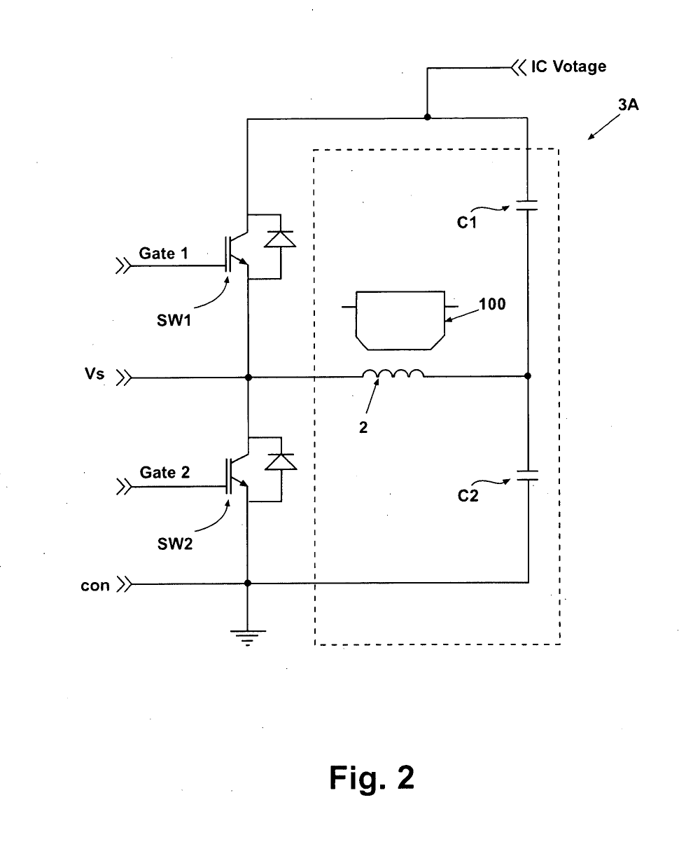

According to a first embodiment of the present invention, a resonant Half-Bridge (HB) converter 3A is formed, the topology of which is schematically shown in FIG. 2. The converter resonant circuit 31A consists of the inductor coil 2 and the capacitors C1-C2 and it is continuously driven by the switches SW1-SW2, thus alternating the current flow direction through the inductor coil 2. The resulting AC current in the inductor coil 2 provides the required time-varying electromagnetic field. The power transfer characteristic is a function of the AC current frequency and of switching duty-cycle and it resembles the shape typical for slightly damped harmonic oscillators. Damping of oscillations is present provided by the portion of resistance of the piece of cookware 100, which is mirrored at the primary winding of the transformer modeling the inductive coupling between the inductor coil 2 and the piece of cookware 100.

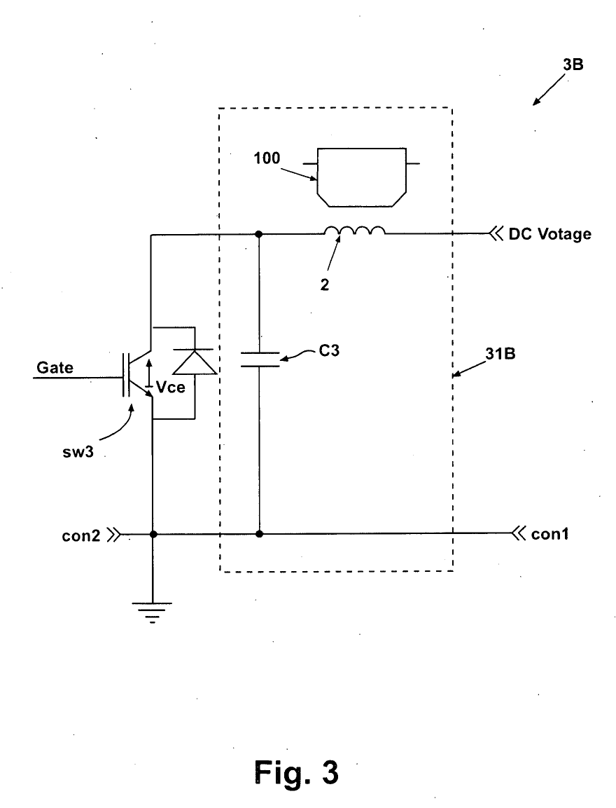

According to a second embodiment of the present invention, a resonant Quasi-Resonant (QR) converter 3B is formed, the topology of which is schematically shown in FIG. 3.

In this case, the resonant circuit 31B comprises the inductor coil 2 and the capacitor C3. The switch SW3 forces a current into the resonant circuit 31B only for a portion (the non-resonant one) of the oscillation time. During the remaining time (when the switch SW3 is OFF) the resonant circuit 31B can freely oscillate as a damped harmonic oscillator. The power supplied to the inductor coil 2 is therefore selected by setting the T_{ON} time, during which the switch SW3 is ON and the inductor coil 2 is charged. The time taken by the resonant circuit 31B to perform an oscillation before the switch SW3 is ON again is called T_{OFF}. The operating frequency of the converter 3B is therefore given by f_{QR}=1/(T_{ON}+T_{OFF}). It is worth to notice that the power transfer characteristic is in a direct relationship to T_{ON} and to the actual impedance at the output leads of the converter 3B. The electrical resistance of the piece of cookware 100 induces an amount of damping of the free oscillations of the resonant circuit 31B.

The control unit 4 comprises detector 41 for providing first data (not shown) related to the complex impedance Z_{COIL}, at the input leads (P1, P2) of the inductor coil 2.

When a resonant HB converter 3A is adopted, said first data can be calculated from first values related the magnitude and phase of the current and/or voltage forced by the HB converter 3A into the inductor coil 2.

Referring to the resonant circuit 31A, it is apparent how the magnitude of the complex impedance Z_{COIL} can be calculated from the rms values of output voltage V_{D} and the driven current I_{COIL}, flowing through the inductor coil 2.

The phase □_{LOAD} of Z_{COIL} can be calculated from the phase displacement □_{ICOIL}, which exists between the output voltage V_{D} and the driven current I_{COIL} and which can be directly measured at the converter 3A outputs. Looking at the topology of the resonant circuit 31A, the following equation (I) can be written:

□_{LOAD}=□_{ICOIL}+□_{VCOIL} (I)

where □_{VCOIL} is the phase of the voltage signal across the inductor coil 2. The term □_{VCOIL} can be calculated from the phase of the driven current I_{COIL}, according to the following equation (II), which can be obtained by performing a Fourier first harmonic analysis of the output voltage V_{D}, assuming that V_{D} is a square wave with a 50% of duty-cycle:

$${Φ}_{V\_COIL} ( ω ) = arctan \{ \frac{\frac{\vert {I}_{COIL} ( ω ) \vert}{ω C} cos [ {Φ}_{{I}_{COIL}} ( ω ) ]}{{V}_{D} ( ω ) + \frac{\vert {I}_{COIL} ( ω ) \vert}{ω C} sin [ {Φ}_{{I}_{COIL}} ( ω ) ]} \} \qquad ( II )$$

in which C=C1+C2.

It should be noticed that the phase □_{LOAD} of Z_{COIL} could be calculated with a same kind of reasoning by considering the phase displacement existing between the output current of the HB converter 3A and the voltage across the inductor coil 2. At the same manner, the current and/or voltage forced on the capacitors C1-C2 could be considered as well.

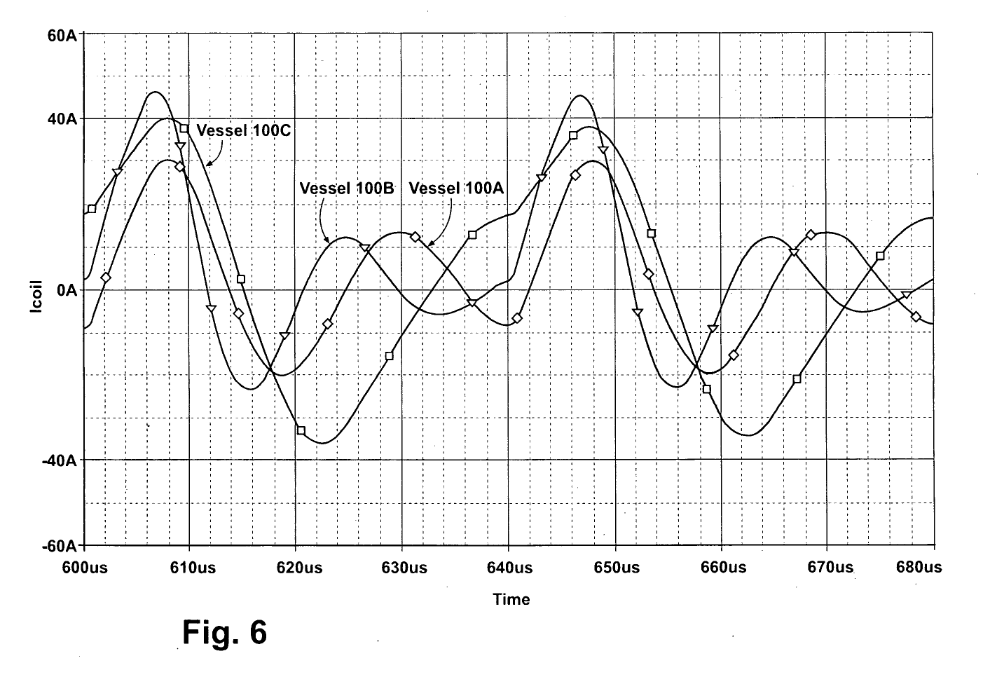

In case a QR converter 3B is adopted, it should be considered that the T_{ON} time determines the actual energy that is supplied to the inductor coil 2 and the piece of cookware 100, as mentioned above. During the T_{OFF} time the resonant circuit 31B is free to oscillate at its natural frequency. The amount of energy transmitted between the inductor coil 2 and the piece of cookware 100 doesn't remain constant and it is dissipated by the real part of the coil complex impedance Z_{COIL}, which is mainly determined by the mirrored portion of the electrical resistance of the piece of cookware 100. The different characteristics of Z_{COIL} determine the peak value of the terminal voltage Vce at solid-state switch during T_{OFF}, or the damping factor of the Vce signal. This means that the mentioned first data can be inferred from the transient parameters of the terminal voltage Vce at the switch SW3, during the resonant portion T_{OFF} of the operation of the QR converter. It should be noticed that the first data can be also obtained from other transient parameters, such as the peak and damping factor of the current I_{COIL} flowing through the inductor coil 2, or any other parameters and/or factors related to the voltages and currents at the output leads of the QR converter. As an example, in FIG. 6, different curves of the current I_{COIL} for different values of Z_{COIL}, which correspond to different pieces of cookware or vessels 100A-100C, are shown. It is evident the relationship between the behaviour of said curves and the different type of vessels 100A-100C.

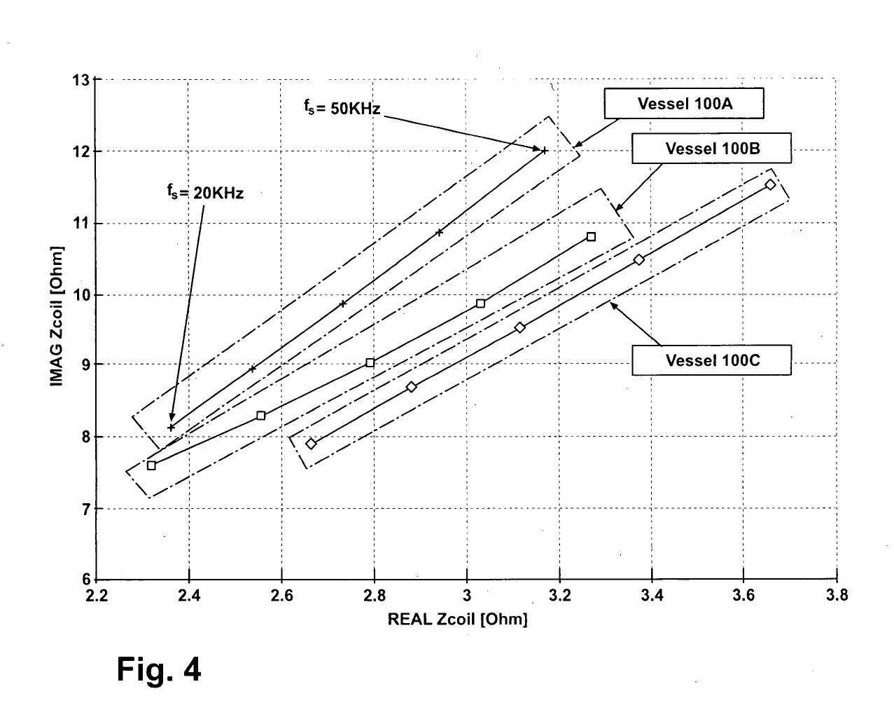

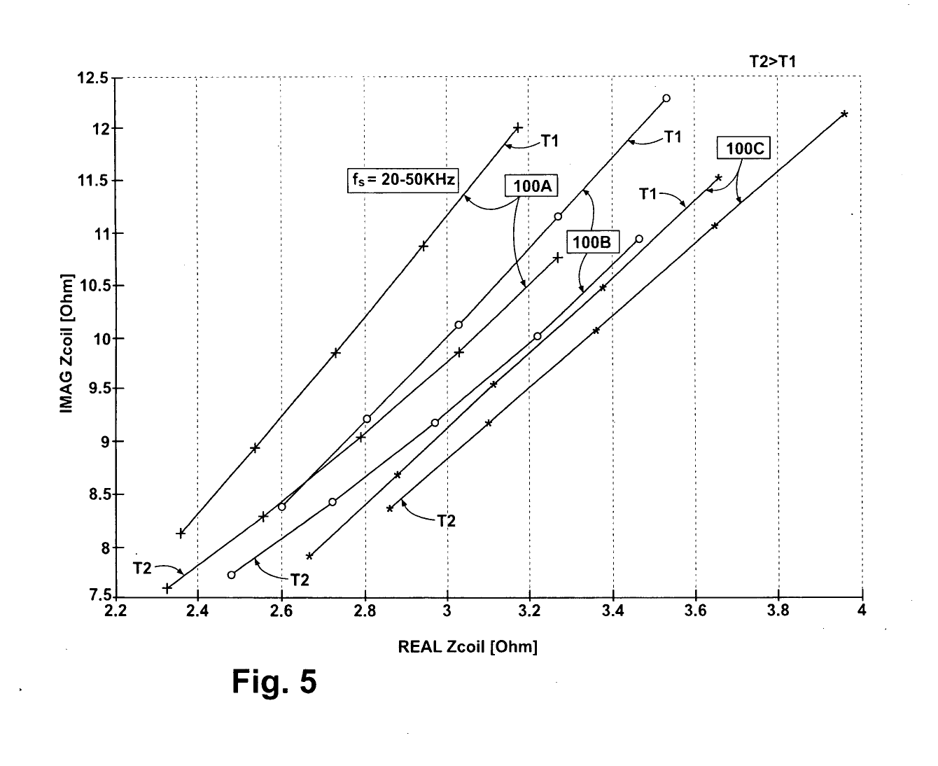

Preferably, the first data are obtained in a parametric manner, for example for different frequencies and/or magnitudes of the current forced on the inductor coil and/or for different temperatures of the piece of cookware 100. In this manner, it is possible to observe possible non-linearities of Z_{COIL} in relation to certain predefined parameters. Referring to FIG. 4, it is possible to appreciate the behaviour of the Z_{COIL} curves, estimated for different pieces of cookware or vessels 100A-100C at different switching frequencies (fₛ) of the switches SW1-SW2. In FIG. 5, it is possible to appreciate the behaviour of the Z_{COIL} curves, estimated for different vessels 100A-100C at different switching frequencies of a HB resonant converter and at different operating temperatures of the piece of cookware 100.

Once the mentioned first data are available from the detector 41, control unit 4 can process them for obtaining second data (not shown) related to the cooking capabilities of the piece of cookware 100, when it is associated to the inductor coil 2. Preferably, the second data are obtained by means of a comparison analysis of the mentioned first data with reference to predefined third data (not shown), which are stored in the control unit 4. In practice, referring again to FIGS. 4-5, the estimated curves of Z_{COIL} can be compared with already available parametric curves, which constitute suitable references for screening the estimated values of Z_{COIL} and for obtaining information related to the actual capabilities of the piece of cookware 100 from this value. For example, taking as a reference FIG. 4, a comparison analysis shows that the vessel 100C is of relatively good quality since it shows a relatively low complex impedance angle (which means a better power transfer characteristic). For the same reasoning the vessel 100A is of poorer quality with respect to the vessels 100B-100C.

Such information is then made available to the user, through a user interface 42, which may provide said second data (or even said first data), in a visual and/or acoustic manner, for example by means of a suitable display, which is preferably set, so as to make a user able to easily understand the information provided in output.

The user interface 42 can also be used for selecting the information to receive in output and/or for selecting the parameters of interest for calculating the first data and/or the second data.

It is apparent how the present invention relates also to a method for checking the cooking capabilities of the piece of cookware 100 that is inductively coupled to an inductor coil 2 at a cooking region 101 of an inductive cooking appliance 1, such as an inductive hob.

Such a method comprises advantageously at least the step i) of providing first data related to the complex impedance Z_{COIL} at the input leads (P1, P2) of the inductor coil 2 and the step ii) of processing the first data, so as to obtain second data related to the cooking capabilities of the piece of cookware 100, inductively coupled to the inductor coil 2.

Preferably, the first data are in parametric relationship, for different frequencies and/or magnitudes of the driven current and/or for different temperatures of the piece of cookware 100.

If the appliance 1 comprises a HB converter 3A, the mentioned step i) comprises preferably the sub-step of obtaining first values related to at least the magnitude and phase of the current and/or voltage forced into the inductor coil 2. As an alternative, the mentioned step i) may comprise the sub-step of obtaining first values related to at least the magnitude and phase of the current and/or voltage forced into one or more capacitors C1-C2 of the converter 3A.

If the appliance 1 comprises a QR converter 3B, the mentioned step i) comprises preferably the sub-step of obtaining second values related to the transient evolution of the voltage and/or current on the inductor coil 2, during the resonant portion of the operation of the QR converter 3B.

In any case, either the first or the second values are calculated, a further sub-step of calculating the first data basing on the first values or the second values is advantageously provided.

Preferably, in the mentioned step ii), the first data are processed by means of a comparison analysis with predefined third data.

The method comprises then a step iii) of providing the user with information related to the first and/or second data at a user interface 42.

It should be appreciated how the method described above can be easily performed by a computer program or by a series of properly programmed software modules stored in the control unit 4 of the appliance 1. The computer program may be activated through the user interface 42, when the user so desires. Such a computer program may also be downloaded the control unit 4 of an appliance 1, which is already installed on the field, so as to update its functionalities.

The inductive cooking appliance 1, according to the present invention, has proven to fulfil the intended aims and objects.

The use of the complex impedance Z_{COIL} values allows to collect a large variety of useful information related to the actual effectiveness of the energy transfer between the inductor coil 2 and the piece of cookware 100. This allows to infer and make available a lot of information concerning the cooking capabilities of a piece of cookware. Therefore, the user does not merely receive an alarm signal but he/she can appreciate the actual cooking capabilities of a certain piece of cookware 100, according to a plurality of physical parameters, which may be selected according to the needs. For example, the user can easily check whether a certain piece of cookware 100 is suitable for cooking a certain food or he/she can select different pieces of cookware in relation to the required cooking performances. As a further example, the provided information can be used to limit the appliance upper level setting that can be adopted for a certain kind of cookware.

The appliance 1 shows a simple structure, in which the integration of the detector (41) and of the user interface into the control unit 4 can be simply achieved. The appliance 1 has therefore proven to be relatively easy to manufacture at industrial level, at relatively low costs.

We claim:

1. An induction cooking appliance comprising:
at least an inductor coil;
electronic driver for driving an AC current through the inductor coil;
a control unit for controlling the operation of the induction cooking appliance;
the control unit comprises a detector for providing first data related to the impedance, at the input leads of the inductor coil when the inductor coil is inductively coupled to a cookware at a cooking region of the induction cooking appliance, wherein the control unit is adapted to process the first data for obtaining second data related to the cooking capabilities of the piece of cookware.

2. The induction cooking appliance, according to claim 1, wherein the impedance at the input leads of the inductor coil is the complex impedance.

3. The induction cooking appliance, according to claim 1, wherein the control unit comprises a user interface for providing the user with the first data and/or the second data.

4. The induction cooking appliance, according to claim 1, wherein the first data are provided for different frequencies and/or magnitudes of the current forced by the electronic driver and/or for different temperatures of the cookware.

5. The induction cooking appliance, according to claim 3, wherein the second data is obtained by comparison analysis of the first data with third predefined data.

6. The induction cooking appliance, according to claim 5, wherein the electronic driver is connected to the inductor coil to form a resonant Half-Bridge converter.

7. The induction cooking appliance, according to claim 6, wherein the detector provides the first data from first values related to the magnitude and phase of the current and/or voltage forced on the inductor coil.

8. The induction cooking appliance, according to claim 6, wherein the detector provides the first data from first values related to the magnitude and phase of the current and/or voltage forced on one or more capacitors (C1, C2) of the Half-Bridge converter.

9. The induction cooking appliance, according to claim 5, wherein the electronic driver is connected to the inductor coil to form a Quasi-Resonant converter.

10. The induction cooking appliance, according to claim 9, wherein the detector provides the first data from second values related to the transient evolution of the voltage and/or current on the inductor coil, during the resonant portion of the operation of the Quasi-Resonant converter.

11. The induction cooking appliance, according to claim 10, wherein that it comprises an induction hob.

12. A method for checking the cooking capabilities of a piece of cookware, which is inductively coupled to an inductor coil at a cooking region of an induction cooking appliance, wherein that it comprises at least the following steps:
providing first data related to the complex impedance at the input leads of at least the inductor coil;
processing the first data, so as to obtain second data related to the cooking capabilities of the piece of cookware.

13. The method, according to claim 12, wherein the step of processing the first data comprises a comparison analysis of the first data with third predefined data.

14. The method, according to claim 13, wherein that it comprises the following step:
providing the user with information related to the second data at a user interface.

15. The method, according to claim 14, wherein the step of providing the first data comprises the following sub-steps:
obtaining first values related to at least the magnitude and phase of the current and/or voltage forced on the inductor coil, when the inductor coil are connected to electronic driver to form a resonant Half-Bridge converter; or
calculating the first data based on the first values.

16. The method, according to claim 14, wherein the step of providing the first data comprises the following sub-steps:
obtaining first values related to at least the magnitude and phase of the current and/or voltage forced on one or more capacitors in resonant connection with the inductor coil, when the inductor coil is connected to the electronic driver to form a resonant Half-Bridge converter;
calculating the first data based on the first values.

17. The method, according to claim 14, wherein the step of providing the first data comprises the following sub-steps:
obtaining second values related to the transient evolution of the voltage and/or current on the inductor coil, during the resonant portion of the operation of a Quasi-Resonant converter formed bay the electronic driver and the inductor coil;
calculating the first data based on the second values.

18. The method, according to claim 17, wherein the first data is calculated for different frequencies and/or magnitudes of the current forced by the electronic driver and/or for different temperatures of the piece of cookware.

19. The computer program comprising instructions for executing a method, according to claim 18.
